(19) United States
(12) Patent Application Publication
(10) Pub. No.: US 2004/0042694 A1
(43) Pub. Date: Mar. 4, 2004

(54) Hydrodynamic bearing system and method for assembling thereof

(75) Inventors: Jurgen Oelsch, Hohenroth (DE); Roland Beckers, Lauffen (DE)

Correspondence Address: SCHULTE ROTH & ZABEL LLP, ATTN: JOEL E. LUTZKER, 919 THIRD AVENUE, NEW YORK, NY, 10022, US

(73) Assignee: Minebea Co., Ltd., Meguro-ku (JP)

(21) Appl. No.: 10/423,164

(22) Filed: Apr. 25, 2003

(30) Foreign Application Priority Data
Aug. 29, 2002 (DE) DE 102 39 651.5

(51) Int. Cl. F16C 32/06

(52) U.S. Cl. 384/107

(57) ABSTRACT

A hydrodynamic bearing system for a spindle motor, preferably for driving magnetic disks in disk drives, having at least one journal bearing, that encompasses a rotatably borne shaft in a bore of a sleeve, and at least one thrust bearing, that encompasses a thrust plate rotatably received in a recess of the sleeve and securely joined to the shaft and a counter-bearing associated with the thrust plate that is in the form of a cover plate. The thrust plate and the cover plate are arranged in a common recess of the sleeve, wherein the cover plate is fixed in the recess in a defined position so that a bearing gap with a desired gap width remains on both sides of the thrust plate.

### CROSS-REFERENCE TO RELATED APPLICATIONS

This application claims all rights of priority to German Patent Application Serial No. DE 102 39 651.5, filed Aug. 29, 2002 (pending).

### BACKGROUND

The invention relates to a hydrodynamic bearing system, in particular to hydrodynamic bearings utilized in spindle motors for disk drives, and a method for assembling the same.

Spindle motors comprise essentially a stator, a rotor, and at least one bearing system arranged therebetween. The electric motor-driven rotor is supported for rotation by the bearing system such that it is rotatable relative to the stator. Rolling bearings and hydrodynamic friction bearings can be used as the bearing system.

A hydrodynamic bearing system includes a bearing sleeve and a shaft that is arranged in an axial bore of the bearing sleeve. The shaft rotates freely in the bearing sleeve. Opposing surfaces of the sleeve and the shaft form a journal bearing. The bearing surfaces of the shaft and the sleeve, which are mutually mechanically linked, are separated from one another by a thin concentric bearing gap filled with a lubricant.

A pattern of grooves is provided on at least one of the bearing surfaces. Due to the relative rotational movement, the groove pattern generates pressure gradients resulting in acceleration forces acting on the lubricant located in the bearing gap. Thus, pumping effect is generated in the lubricant leading to the formation of a homogeneous and uniformly thick film of lubricant that is stabilized by zones of hydrodynamic pressure.

The cohesive capillary lubricant film and the self-centering mechanism of the hydrodynamic journal bearing ensure stable, concentric rotation between shaft and bushing.

Appropriately designed hydrodynamic thrust bearings prevent shaft displacement along the axis of rotation. In a hydrodynamic thrust bearing, the bearing surfaces that are mutually mechanically linked, are each arranged in the plane perpendicular to the axis of rotation and are axially separated from one another by a thin, preferably even bearing gap that is filled with lubricant. At least one of the thrust bearing surfaces is provided with a pattern of grooves, which generate axial pressure gradients during the rotation.

Since a single hydrodynamic thrust bearing typically can only take up forces in one direction, generally two hydrodynamic thrust bearings working in opposition to one another are provided.

The stiffness of hydrodynamic bearings is largely determined by the bearing gap thickness, the viscosity of the lubricant, and the shape and/or design of the pattern of grooves.

Hydrodynamic thrust bearings provided to take up the axial forces are preferably formed by two end faces of a thrust plate arranged at the end of the shaft, and a corresponding end face of the sleeve, positioned opposite to one end face of the thrust plate, and an inner end face of a cover plate, positioned opposite to the other end face of the thrust plate. The cover plate thus forms a counter-bearing to the thrust plate, seals the entire bearing system at the bottom of the sleeve and prevents air from penetrating into the bearing gap filled with lubricant.

The specific advantages of hydrodynamic friction bearings as opposed to rolling bearings are the higher running precision, the insensitivity to shock loads, and the smaller number of components. Since the sliding elements do not touch one another at nominal speed, they work with a low rate of wear and nearly soundlessly.

U.S. Pat. No. 6,183,135 B1 discloses a hydrodynamic bearing system described in the foregoing with a thrust plate arranged on one end of the shaft. The thrust plate is received in a first sleeve recess adapted to the dimensions of the thrust plate and is covered by a cover plate that is arranged in a second sleeve recess of greater diameter. The greater diameter of the second recess results in a step being formed inside the bearing sleeve that acts as an axial stop for the cover plate.

Due to the manufacturing tolerances in the thickness of the thrust plate and the depth of the first recess, the dimensions of the bearing gap surrounding the thrust plate in the axial direction vary by up to 50%, for which reason the bearing stiffness also varies widely.

### SUMMARY OF THE INVENTION

The object of the invention is to provide a hydrodynamic bearing system in which variance of the bearing gap in the thrust bearing due to the manufacturing tolerances are minimized.

A method for assembling such a bearing system is also provided by the present invention.

In accordance with the invention, the bearing system has at least one journal bearing that encompasses a rotatably supported shaft in a bore of a sleeve. The bearing system further includes at least one thrust bearing having a thrust plate, which is securely joined to the shaft, and a counter-bearing associated with the thrust plate. The counter-bearing is preferably formed as a cover-plate. The thrust plate and the cover plate are arranged in a common recess of the sleeve.

In one preferred embodiment of the invention, the diameter of the recess is greater than the diameter of the bore so that a step is formed in the bearing sleeve. The cover plate is arranged at a distance of A=a+2G from the step and is affixed there. Wherein, A is the remaining clearance height of the common recess, a is the thickness of the thrust plate, and G is the required width of the thrust bearing gap.

The cover plate is preferably introduced into the recess using a transition fit and joined to the sleeve by welding or gluing.

The method for assembling the hydrodynamic bearing system preferably has three steps. First, the shaft and thrust plate securely joined thereto are inserted into the bearing sleeve such that the thrust plate is placed immediately adjacently to the step formed in the sleeve by different diameters of the bore and the common recess. Next, the cover plate is introduced into the common recess such that it is adjacent to the free side of the thrust plate. Finally, the cover plate is pushed back to a defined distance by a displacement movement of the shaft, wherein the distance is equal to twice the value of the desired gap width G; and affixed to the sleeve in this position.

The invention offers various advantages to the prior art.

For example, processing of the sleeve is simplified since only one common recess must be provided for receiving the thrust plate and the cover plate. Also, the tolerances of the axial dimensions of thrust plate, cover plate, and recess are less critical since the gap width G can be adjusted as desired, regardless of the dimensions of these parts.

This results in a very precisely reproducible gap width, which means that bearings with uniform bearing properties can be produced, even in large numbers.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1: is a schematic sectional view of the bearing system in accordance with the present invention;

FIG. 2: is a schematic sectional view of a bearing system in accordance with the prior art.

### DESCRIPTION OF A PREFERRED EMBODIMENT OF THE INVENTION

The exemplary embodiment illustrates a spindle motor for driving a disk drive with an inventive hydrodynamic bearing system. In the example illustrated, a shaft carrying a rotor is rotatably borne in a fixed bearing sleeve. Of course, the invention also encompasses designs in which a fixed shaft is enclosed by a rotatable bearing sleeve that carries the rotor.

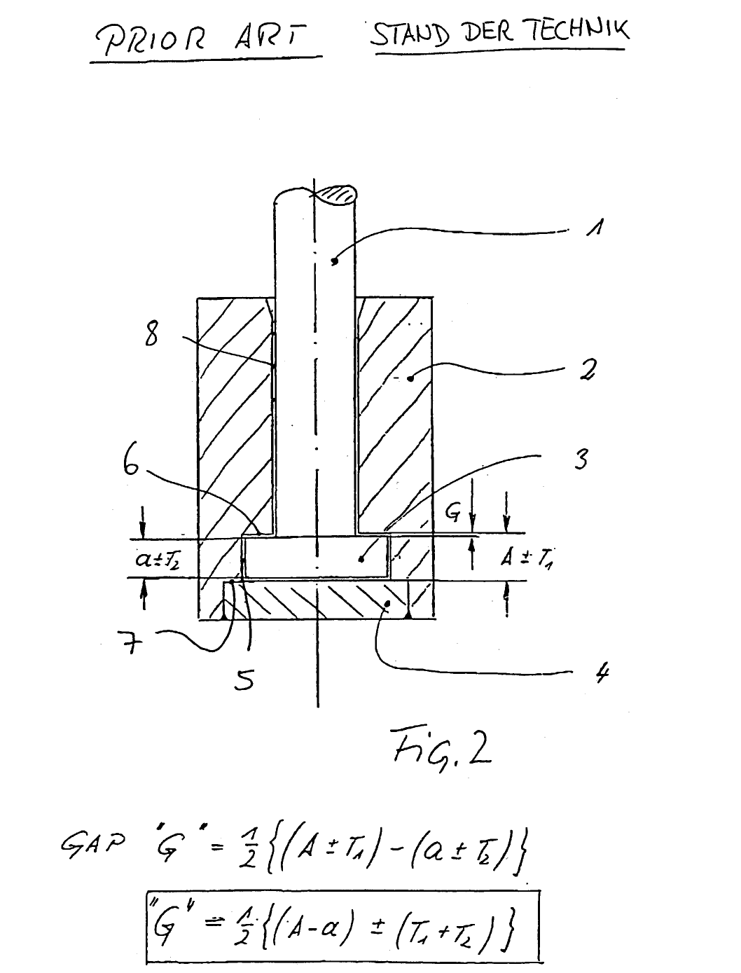

FIG. 2, which illustrates the prior art, shows a bearing system with a shaft 1 arranged for a free rotation in a bore of the sleeve 2. A journal bearing is formed between the opposing surfaces of the shaft 1 and sleeve 2. At least one of these opposing surfaces has cylindrical zones with groove patterns provided thereon (not shown) in a known manner.

The lower end face of the sleeve 2 is provided with a first annular recess 5 for receiving a thrust plate 3. Thrust plate 3 is securely mounted on the shaft for free rotation with the shaft within recess 5. Thrust plate 3 has a concentric bore for receiving shaft 1. The lower opening of sleeve 2 is hermetically sealed by a cover plate 4 forming the counter-bearing. The cover plate 4 is received in a second recess having a greater diameter than the first recess. A second step 7 is formed in the bearing sleeve between the first recess and the second recess and the cover plate is placed adjacently to the second step 7. The cover plate 4 prevents air from penetrating into the bearing system and prevents any lubricant from escaping from the bearing gap.

The exterior diameters of shaft 1 and thrust plate 3 affixed thereto are slightly smaller than the corresponding interior diameter of the bushing 2 and recess 5, respectively. Likewise, the thickness of the thrust plate 3 is less than the depth of the recess 5 between the two steps 6 and 7. The bearing gap, that results from the differences in dimensions and that is formed between the shaft 1 with thrust plate 3 and the sleeve 2 sealed by the counter-plate 4, is filled with a lubricant forming a cohesive lubricant film such that the shaft 1 with thrust plate 3 can rotate inside the sleeve 2 with no contact. At least one pattern of grooves is formed on one of the opposing cylindrical bearing surfaces of shaft 1 and sleeve 2, the surfaces being spaced by the bearing gap above the thrust plate 3. The groove pattern forms a hydrodynamic journal bearing. Due to the rotational relative movement between shaft 1 and sleeve 2, a concentric cushion of pressure gradients builds up in the bearing gap. The pressure gradients are directed radially inward and the geometric sum of these gradients is zero. Each deviation from this force equilibrium caused by changes in spacing in the bearing gap is immediately compensated in a self-regulating manner such that the axis of rotation is in a force-stable and position-stable equilibrium.

Provided in the region of the steps 6 and 7 are hydrodynamic thrust bearings whose force components, caused by the hydrodynamic cushion of pressure point in the axial direction, are mutually of the same size, and therefore also ensure self-stabilizing force equilibrium and position equilibrium in the axial direction.

A first hydrodynamic thrust bearing with an associated first pattern of grooves is provided in the region of the step 6 and is formed between the opposing circular end faces of the sleeve 2 and the thrust plate 3 that are spaced from one another by a first axial bearing gap. A second hydrodynamic thrust bearing with a second pattern of grooves is located in the region of the step 7 on the lower side of the thrust plate 3 and is formed between the opposing end faces of the thrust plate 3 and the counter-plate 4 spaced apart by a second axial bearing gap.

The dimensions of the bearing gap G between the upper axial surface of the thrust plate 3 and the sleeve 2 and between the lower axial surface of the thrust plate 3 and the cover plate 4 is determined by the clearance height A of the first recess 5 plus a tolerance ±T₁ less the thickness a of the thrust plate 3 plus a tolerance ±T₂. Given the simplified assumption that both axial bearing gaps are the same size, that is, G1=G2=G, then:

$$\begin{matrix}Gap width G = 1 / 2 \{ ( A \pm {T}_{1} ) - ( a \pm {T}_{2} ) \} \\ = 1 / 2 \{ ( A - a ) \pm ( {T}_{1} + {T}_{2} ) \}\end{matrix}$$

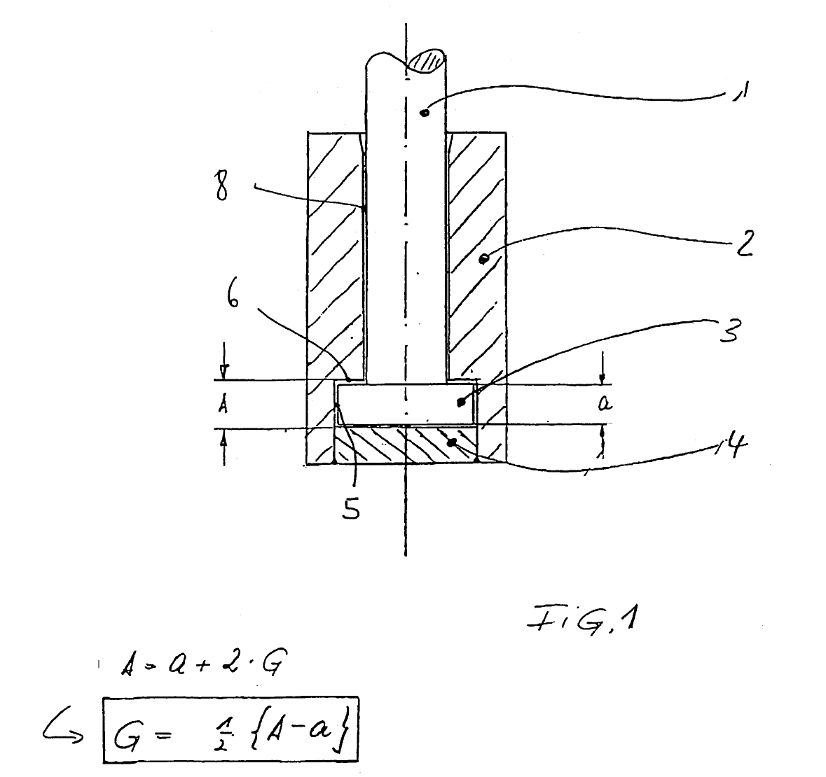

The inventive bearing system is illustrated in FIG. 1. The structure of this bearing system is similar to the bearing system illustrated in FIG. 2. Identical parts are given identical reference numbers. However, the invention in accordance with FIG. 1 is distinguished in that the sleeve 2 has only one common recess 5 for jointly receiving the thrust plate 3 and the cover plate 4.

The exterior diameter of the thrust plate 3 is selected such that on the one hand it is freely rotatable within the recess 5 and, on the other hand, the gap width between its exterior circumference and the interior circumference of the recess equals a predefined value. The exterior diameter of the cover plate 4 is preferably approximately equal to the interior diameter of the recess 5 so that it can be arranged in the recess using a transition fit and can be affixed there by welding or gluing, for example.

When the bearing system is assembled, the shaft 1 with the thrust plate 3 securely mounted thereon is inserted into the sleeve 2 such that the thrust plate is located immediately adjacently to step 6 formed by the different diameters of the bore 8 and the recess 5 of the bearing sleeve. The cover plate 4 is then inserted into the recess 5 and pressed against the lower side of the thrust plate 3.

In the next step, the cover plate 4 is pushed back towards the sleeve's opening by a displacement movement of the shaft 1. The distance of the displacement is equal to twice the desired gap width G. This displacement movement by the distance 2G can be achieved using a highly accurate final control element that engages at the shaft 1.

The cover plate 4 is then securely joined to the sleeve 2 in this predetermined position by welding or gluing, for example. A defined gap of the width G remains between the thrust plate 3 and the step 5, on one side of the thrust plate, and between the thrust plate 3 and the cover plate 4, on the other side of the thrust plate.

The distance by which the cover plate should be displaced is equal to twice the gap width 2G, where:

G=½(A−a).

In terms of the inventive assembly method, the actual dimensions (thickness a) of the thrust plate and the remaining clearance height A of the recess are not important, since the gap width G is adjusted regardless thereof.

The described type of assembly for the bearing system permits the bearing gap G to be precisely reproduced down to a few μm.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

What is claimed is:

1. A hydrodynamic bearing system for a spindle motor, comprising:
a shaft;
a bearing sleeve, said sleeve having a recess;
at least one journal bearing formed between said shaft and said bearing sleeve;
a thrust plate fixedly mounted on said shaft;
a cover plate enclosing said sleeve; and
at least one thrust bearing formed between said thrust plate and said counter plate,
wherein said thrust plate and said cover plate are commonly received in said recess of said bearing sleeve.

2. The hydrodynamic bearing system in accordance with claim 1, wherein said sleeve further comprises a bore encompassing said shaft, wherein a diameter of said recess is greater than the diameter of said bore, and wherein a step is formed between said bore and said recess.

3. The hydrodynamic bearing system in accordance with claim 2, wherein said cover plate is arranged and fixed at a distance of A=a+2G from said step and wherein a is a thickness of said thrust plate, and G is a width of a thrust bearing gap.

4. The hydrodynamic bearing system in accordance with claim 1, wherein said cover plate is arranged in said recess using a transition fit and joined securely to said bearing sleeve.

5. A spindle motor having a hydrodynamic bearing, said hydrodynamic bearing comprising:
a shaft;
a bearing sleeve, said sleeve having a recess;
at least one journal bearing formed between said shaft and said bearing sleeve;
a thrust plate fixedly mounted on said shaft;
a cover plate enclosing said sleeve; and
at least one thrust bearing formed between said thrust plate and said counter plate,
wherein said thrust plate and said cover plate are commonly received in said recess of said bearing sleeve.

6. The spindle motor in accordance with claim 5, wherein said sleeve further comprises a bore encompassing said shaft, wherein a diameter of said recess is greater than the diameter of said bore, and wherein a step is formed between said bore and said recess.

7. The spindle motor in accordance with claim 6, wherein said cover plate is arranged and fixed at a distance of A=a+2G from said step and wherein a is a thickness of said thrust plate, and G is a width of a thrust bearing gap.

8. The spindle motor in accordance with claim 5, wherein said cover plate is arranged in said recess using a transition fit and joined securely to said bearing sleeve.

9. A method for assembling a hydrodynamic bearing system comprising the steps of:
inserting a shaft with an attached thrust plate into a bore of a bearing sleeve having a recess such that said thrust plate is placed into said recess adjacently to a step formed in said bearing sleeve between said bore and said recess;
placing a cover plate into said recess adjacently to one side of said thrust plate;
pushing said cover plate back into a predetermined position by a displacement movement of said shaft; and
affixing said cover plate to said bearing sleeve in said predetermined position,
wherein said predetermined position is defined by a distance 2G, said distance 2G being equal to twice the value of a desired bearing gap width G.
